(19) United States
(12) Patent Application Publication
(10) Pub. No.: US 2017/0213268 A1
(43) Pub. Date: Jul. 27, 2017

(54) METHOD FOR FACILITATING A TRANSACTION USING A HUMANOID ROBOT

(71) Applicant: MASTERCARD ASIA/PACIFIC PTE LTD, Singapore (SG)

(72) Inventors: Tobias PUEHSE, Singapore (SG); Jie ZHANG, South East Singapore (SG)

(73) Assignee: MASTERCARD ASIA/PACIFIC PTE LTD, Singapore (SG)

(21) Appl. No.: 15/403,256

(22) Filed: Jan. 11, 2017

(30) Foreign Application Priority Data
Jan. 25, 2016 (SG) 10201600561Y

(51) Int. Cl. G06Q 30/06; B25J 11/00; G10L 15/22; G10L 13/00; G10L 17/26; G10L 17/22; G10L 17/06; G06Q 20/40; G10L 15/08

(52) U.S. Cl. CPC G06Q 30/0613; G06Q 30/0635; G06Q 20/40145; B25J 11/0005; B25J 11/0015; G10L 15/22; G10L 15/08; G10L 17/26; G10L 17/22; G10L 17/06; G10L 13/00; G10L 2015/223; G10L 2015/088

(57) ABSTRACT

The present disclosure relates to methods for facilitating a transaction. The methods involve interaction with a humanoid robot and include using the humanoid robot to receive a session initiation instruction from a user. During the session one or more articles are identified for purchase, each article being a product or service. A checkout sequence is then initiated to purchase the one or more articles. At some stage during performance of the above steps, beforehand or afterwards, the user is authenticated via interaction with the humanoid robot.

### TECHNICAL FIELD

The present disclosure relates to the use of humanoid robots in performing transactions.

### BACKGROUND

The ease of purchasing products online, and the ready availability of cheap imports, has placed increasing pressure on in-store customer service in attracting shoppers. The high cost of providing in-store customer service has led to a reduction in the number of in-store employees, consequent increasing demands on the time of in-store employees, and thus a further degradation in in-store customer service.

To reduce the demands on in-store employees, and to make information readily available to shoppers, interactive store maps are increasingly common. These maps allow a user to navigate through a fixed set of data, using a standard set of commands typically involving interaction with a touchscreen to sequentially navigate through progressively lower-levels of data until the desired information is displayed to the user.

Existing interactive store maps are based on fixed information accessed in a standardised manner. Such maps cannot tailor information to the user or assist the user with non-standard queries. In addition, an interactive store map does not act in a manner that is familiar to many users, thus requiring shoppers to approach in-store employees for information they are unable to locate using the interactive store map.

It would be useful to provide a method for locating products and performing purchase- or checkout-related tasks in a manner that takes into account the specific user and/or the user's needs.

### SUMMARY

In accordance with the present disclosure, there is provided a method for facilitating a transaction, comprising:
receiving, using a humanoid robot, a session initiation instruction from a user and initiating a product selection session;
authenticating the user via interaction with the humanoid robot;
identifying one or more articles for purchase by the user; and
initiating a checkout sequence for purchasing the one or more articles.

Also described herein is a computer system for facilitating a transaction, the computer system comprising:
a memory device for storing data;
a display; and
a processor coupled to the memory device and being configured to:
   receive, using a humanoid robot, a session initiation instruction from a user and initiating a product selection session;
   authenticate the user via interaction with the humanoid robot;
   identify one or more articles for purchase by the user; and
   initiate a checkout sequence for purchasing the one or more articles.

Further described herein is a computer program embodied on a non-transitory computer readable medium for facilitating a transaction, the program comprising at least one code segment executable by a computer to instruct the computer to:
receive, using a humanoid robot, a session initiation instruction from a user and initiating a product selection session;
authenticate the user via interaction with the humanoid robot;
identify one or more articles for purchase by the user; and
initiate a checkout sequence for purchasing the one or more articles.

### BRIEF DESCRIPTION OF THE DRAWINGS

Some embodiments of the present invention will not be described, by way of non-limiting example only, with reference to the accompanying drawings in which:

FIG. 1 illustrates a method for facilitating a transaction in accordance with the present disclosure;

FIG. 2 illustrates a humanoid robot usable in a method for facilitating a transaction in accordance with the present disclosure;

FIG. 3 shows a schematic of a system for performing the method of FIG. 1; and

FIG. 4 shows an exemplary computing device suitable for executing the method of FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analysing”, “determining”, “replacing”, “generating”, “initializing”, “initiating”, “receiving”, “outputting”, or the like, refer to the action and processes of a computer system, or similar electronic device such as a humanoid robot, that manipulates and transforms data represented as physical quantities within the computer system into other data similarly represented as physical quantities within the computer system or other information storage, transmission or display devices including display by gesture movement replicating movements of a human.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus, with the exception that gesture-related outputs and specific verbal, tonal outputs are intended to be produced on a humanoid robot. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a humanoid robot and/or general-purpose computer interacting with a humanoid robot, effectively results in an apparatus that implements the steps of the preferred method.

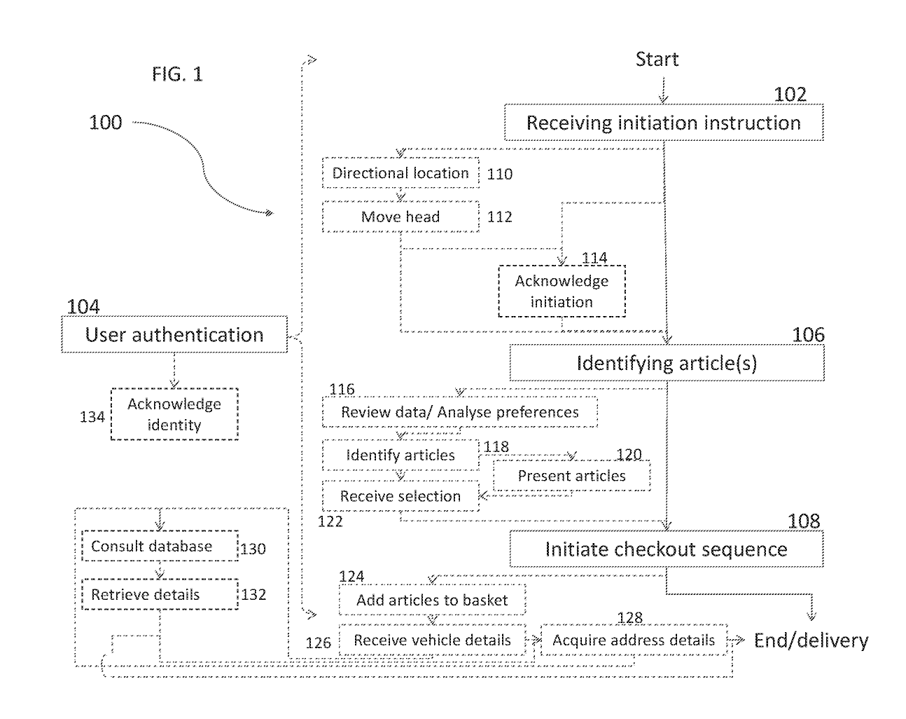

The method 100, as shown in FIG. 1, is used for facilitating a transaction. The method broadly includes the steps of:
Step 102: receiving a session initiation instruction;
Step 104: authenticating a user;
Step 106: identifying articles—i.e. product(s) or service(s); and
Step 108: initiating checkout.

The step 102 of receiving a session initiation instruction involves the humanoid robot receiving a command from a user to initiate a product selection session—a period of interaction between a user and the humanoid robot intended to facilitate selection of products and/or services and ultimately a transaction to purchase one or more products and/or services.

The session initiation instruction may be take various forms, such as a verbal instruction, a touch command or a visual cue or a secondary computing device (for example, a mobile computing device such as a smart phone). The secondary computing device may communicate with the humanoid robot and/or a further computing system which is in communication with the humanoid robot, for example using a wireless communications protocol such as Bluetooth or WiFi.

Where the session initiation instruction comprises a verbal command, the session initiation instruction may be received through a listening device. The listening device may be one or more receivers, microphones or probes. Where a probe comprises an acoustic particle probe it may be used to determine the acoustic particle velocity and thereby the direction from which the verbal command was received—in other words, the direction of the user (110). Where two or more microphones or receivers are used, the difference in timing of receipt of the same verbal command through the microphones may be used to triangulate the signal and thereby determine the direction from which the verbal command was received.

The one or more receivers, microphones or probes may be provided at different locations of the humanoid robot.

After the direction of the verbal command has been determined, the humanoid robot may turn to face the user (112). This provides a more familiar response to the user than if the humanoid robot were to maintain the same head orientation regardless of the position of the user relative to the humanoid robot.

The session initiation instruction may instead comprise a touch command. The touch command may be received through a touch panel or touchscreen. In such circumstances, the user will typically position themselves in front of the panel through which the touch command is provided.

The humanoid robot may record one or more speech segments—being a string of words or a sound file recorded over a predetermined period of time—for analysis, or may process the one or more speech segments in real time. Where a speech segment is received by the humanoid robot through one or more listening devices, the speech segment may be analysed and a session initiation instruction located in the one or more speech segments.

The humanoid robot may use speech recognition techniques to identify a string of one or more words in the speech segment, where the one or more words comprise the initiation instruction. Alternatively, the humanoid robot may listen to speech from a user and identify an enquiry in the speech. For example, where the humanoid robot hears “Now where would I find the shampoo”, the humanoid robot may initiate a session with the user, turning toward the user if needs be based on the direction of the user relative to the humanoid robot, and respond with a human response. For example, the humanoid robot may respond with “May I help you find the shampoo you are looking for?” or “If you are trying to find shampoo, I would suggest looking in aisle 8.” Instead of identifying an enquiry based on a sequence of words forming a question, a recognisable enquiry may comprise a particular word suggesting the user requires information, such as “Where” or “Find”, or even an upward inflection at the end of a sentence.

The session initiation instruction or command may be intentional, for example a command or standard phrase such as “Start purchase” or “Initiate”, or may be unintentional. An unintentional command may involve the humanoid robot listening to speech from one or more surrounding people, and recognising an enquiry or instruction in that speech.

The session initiation instruction may alternatively comprise a visual cue. To identify a visual cue the humanoid robot may analyse movement at various locations around the robot. The movement may be recorded through one or more cameras, such as a wide angle camera, a high-definition camera or a 3-dimensional camera.

The humanoid robot may determine whether a movement recorded through the one or more cameras comprises:
a waving action;
another form of hand signal recognising the presence of the humanoid robot;
a nod of the head in the direction of the humanoid robot;
a pause indicating the user is awaiting initiation of a session by the humanoid robot;
another gesture or body movement that may be interpreted as a desire to initiate interaction with the humanoid robot; or
an image displaying an optically readable code (e.g. a QR code/barcode, etc.).

In effect, the step 102 of receiving a session initiation instruction comprises identifying a session initiation instruction. The humanoid robot may then respond with visual and/or audio cues. For example, the humanoid robot may:
respond to a wave gesture by waving back to the user;
respond to a speech segment using a human response—for example, a speech segment stating “Can I hire a carpet cleaner here?” may be responded to with “You certainly can. Our counter for hiring carpet cleaners is located toward the rear-left of the shop.” The first sentence, “You certainly can”, may be accompanied by a smile or other gesture. The second sentence, “Our counter for hiring carpet cleaners is located toward the rear-left of the shop”, may be accompanied by hand movements from the humanoid robot showing the way to the relevant area. The humanoid robot may also move to the relevant area and thereby take, or escort, the user to that area.

The step 106 of identifying one or more articles may be achieved in various ways—hereinafter the word ‘article’ or ‘articles’ may be interchangeably used with ‘product’ or ‘products’, and the same concepts are intended to apply to ‘services’. The products may be selected by touch gestures on a touchscreen. Alternatively, the humanoid robot may receive a speech segment containing product information and identify, from a database of products, one or more products corresponding to that product information. For example, the humanoid robot may identify a particular product name, brand name or other product identifier and use that information to locate the desired product in the database of products.

The humanoid robot may also make product recommendations. For example, the humanoid robot may use product association to recommend additional products such as when a user intends to purchase shampoo the humanoid robot may also recommend purchasing conditioner. Such associations may be made using various forms of data: one such form may be associations provided by product suppliers—where a user selects a particular brand of shampoo for purchase, the same brand of conditioner or soap may also be recommended. Another form may be to (a) review purchase data of previous transactions that include the product or products (116), (b) identify one or more additional products from the purchase data (118), optionally present the additional product(s) to the user (120), and (c) receive a user selection of at least one of the additional product(s) (122).

The humanoid robot may also be Internet enabled, or otherwise have access to databases of information about various users collected over time. When a user surfs the Internet, for example, user preference information is gathered and can be used to specify additional products the user may wish to purchase. In such a scenario, the step 106 of selecting one or more articles for purchase may involve (a) analysing a record of user preference information (116), (b) identifying one or more products from the user preference information (118), and optionally display the products (120), and (c) receiving a user selection of one or more of the recommended products (122).

The humanoid robot may also use physical characteristics of the user to recommend products. The humanoid robot may identify physical features of the user indicating whether the user is male or female, the approximate age of the user and other characteristics, and use those characteristics to recommend products. For example, when the humanoid robot is in a clothing store and the user is determined to be a male, aged 25 to 30, the humanoid robot may recommend styles of clothing typically purchased by males of that age group.

Other recommendation methods which are known in the art may be employed with certain embodiments. For example, use may be made of recommendation algorithms such as collaborative filters, content-based filters or hybrid recommenders.

When recommending products to the user, the humanoid robot may use an audio output stating the nature of the products, or may present a visual description of the products. The visual description of the products may be provided on a screen attached to, or held by, the humanoid robot. The audio or visual output may be accompanied by gestures such as a supination of hands of the humanoid robot.

The selected products are collected in a virtual shopping basket (124). The virtual shopping basket can then be used to initiate transactions on the products, such as a checkout sequence per step 108.

In one embodiment, the checkout sequence involves an in-store checkout operation. In this case, the humanoid robot allocates a session or basket identifier to the session or basket. The session identifier may be the user's name, the user's payment vehicle, a sequentially or randomly allocated number or any other identifier.

After a session identifier is allocated, the session may be temporarily suspended. This enables the user to collect the articles for the basket and either return to the humanoid robot or proceed to an in-store checkout, and reactivate the session in order to complete the transaction on the articles.

In the case where the user collects the various products from the store in which the humanoid robot is located, and returns to the humanoid robot to complete a transaction on the products, the session or basket identifier can then be used to reactivate the session and enable the user to purchase the articles in the basket. The identifier in this case may be a number but, since the user has already interacted with the humanoid robot, may alternatively comprise a predetermined sequence of words, the user's name or a gesture set by the user by which to reactivate the session.

The user may alternatively proceed to an in-store checkout. In this case, the session or basket identifier may be sent to the in-store checkout so that the user can readily reactivate their session.

When the user fills their basket by interacting with the humanoid robot, they may be presented with value-added services. For example, a user may be recognised and their details acquired from one or more value-added services providers. The user may then be offered discount, reward points redemption options and other value-added services that make the transaction more attractive for the user. By allocating a session or basket identifier, reactivation of the session may also take into account any desired discounts, redemptions and so forth, previously selected by the user. The user therefore shop in-store, knowing in advance what their basket is going to cost, and knowing what discounts or value-added services they are to receive, and not have to go through the same value-added services selection at the in-store checkout.

Thus, once the session identifier is passed to the checkout and the session is reactivated the products in the user's physical basket are confirmed and the transaction process commences using the previously determined product pricing and user-selected value-added services.

The transaction is then completed once payment vehicle details have been acquired and payment has been made.

The user may instead prefer to have their products delivered to a particular address, or may schedule services to be provided at the particular address. This is similar to an online purchase transaction and, in this case, a virtual shopping basket may be used in the same manner as virtual shopping baskets are used in online purchases, to collect products and services.

To transact using a virtual shopping basket, payment vehicle details of a payment vehicle of the user are collected (126). The payment vehicle details may be collected using a payment interface, such as a magnetic card reading terminal, a cash receipt slot, an NFC chip reader for reading the NFC chip on a payment vehicle or a virtual wallet. Payment vehicle details may also be received by authenticating the user as discussed below, and identifying payment details of the user from a database of user accounts. In this process, payment vehicle details can be extracted by consulting a database or user record (130) and retrieving those details (132), and address details (128) may be similarly extracted. The user then approves use of the credit card verbally (e.g. by saying “Approve” or by providing a predetermined approval word or phrase), by gesture or by touch (e.g. inputting a personal identification number (PIN) on a touchpad), or by a secondary computing device from the user (for example, smartphone)

The method 100 also includes step 104 of authenticating the user. The user is authenticated when their identity is confirmed or known. The identity may be the user's name, social security code or any other identifier that uniquely identifies the particular user over other users.

While authentication may involve the simple process of obtaining payment vehicle information and having the user authenticate use of the payment vehicle in a standard manner, authentication may also involve other processes and take place at a time other than at checkout or immediately before checkout.

The user may also be authenticated at step 104 to cross-reference the user with data collected on the user's Internet activities, thereby to recommend products. The user may be authenticated to automatically acquire payment vehicle details, address details and/or other details about the user by which to facilitate the checkout process.

User authentication may involve active authentication using a prescribed, active process whereby the humanoid robot receives one or more pieces of identifying information from the user and uses that identifying information to authenticate the user. For example, the humanoid robot may receive, verbally or through a touchpad, the user's name, date of birth and other details so as to uniquely identify the user. Alternatively, the user authentication process may be passive.

Passive authentication can occur while other steps of the method are being carried out—in other words, authentication occurs in the background during performance of steps 102, 106 and/or 108.

For either active or passive authentication, authenticating the user can involve receiving a speech segment from the user. The speech segment is analysed to locate identifying information such as the user's name or locating another word or words in the speech segment that describe the user (e.g. the user's date of birth).

Particularly for passive authentication, the identifying information located in the speech segment can include a voice biometric or ‘voice print’. The voice biometric enables the user to be identified using their natural speech such as when requesting information from, or responding to, the humanoid robot. This makes the authentication process more natural and familiar for the user, since they are not necessarily required to adhere to a prescribed dialogue with the humanoid robot in order to be authenticated.

Where a voice biometric is used to authenticate the user, the speech segment may be analysed to extract that voice biometric. Using known mathematical processes, the following may be extracted and used as voice biometrics by which to distinguish the user from all other people:
dialect—the specific form of language used by the user, as represented in syllabic emphases, phraseology and terminology; vocal pitch;
spectral magnitudes relating to frequencies in the speech segment; syllabic emphasis of particular words;
tonal emphasis such as the drawing out or shortening or particular tones in words; and
timing.

Once one or more voice biometrics are determined from the speech segment, the voice biometric or biometrics are compared to one or more stored voice biometrics in order to determine similarities. In this regard, it is believed that vocal characteristics as represented in voice biometrics can be as uniquely identifying of the user as a fingerprint. Thus the comparison of the voice biometric or biometrics ascertained from the speech segment to the stored biometrics can be used to determine a statistical likelihood of the identity of the user—in other words, where the correlation between the voice biometric of the speech segment and one, unique stored voice biometric means it is statistically likely that the person associated with the one, unique biometric is the person now interacting with the humanoid robot in the present session, then that user may be considered ‘authenticated’. Statistical likelihood or statistical similarity may be determined as a condition where the voice biometric (or other quantity) is more similar to a single user voice profile (being a record comprising comparable voice biometrics), as stored in a database of user voice profiles, than any other user profile. Alternatively, the voice biometric may be similar to more than one user profile but, probabilistically, there is a user more likely to be the user interacting with the humanoid robot than any of the other statistically similar users—for example, where only one of the statistically similar users lives or shops (as determined by the locations set forth in past transaction data—e.g. credit card transactions) in the geographical vicinity of the humanoid robot.

In some embodiments, the biometric may be a facial and/or gesture biometric, such as features or landmarks extracted by a facial recognition algorithm (including a geometric algorithm or a photometric algorithm) based on images captured by one or more optical sensors of the humanoid robot. Suitable recognition algorithms include Principal Component Analysis using eigenfaces, Linear Discriminate Analysis, Elastic Bunch Graph Matching using the Fisherface algorithm, the Hidden Markov model, the Multilinear Subspace Learning using tensor representation, and the neuronal motivated dynamic link matching. In some embodiments a 3D facial recognition algorithm may be used (for example, the algorithm described in Bronstein, A. M.; Bronstein, M. M.; Kimmel, R. (2005), “Three-dimensional face recognition”, International Journal of Computer Vision (IJCV) 64 (1): 5-30; or that described in in Gupta, S.; Markey, M. K.; Bovik, A. C. (2010). “Anthropometric 3D Face Recognition”. International Journal of Computer Vision (IJCV) 90 (3): 331-349).

In some embodiments, a secondary persistent authentication device may be used to authenticate the user. The secondary persistent authentication device may be a wearable device which monitors one or more biometrics of the user, such as Nymi Band of Nymi, Ontario, Canada.

The user may also combine passive and active modes of authentication. For example, in addition to voice biometrics the user may provide their name, thereby greatly reducing the number of stored voice biometrics available for comparison, and proportionally increasing the likelihood that the voice biometrics determined from the speech segment will be much more similar to one stored voice biometric than any other.

Once authenticated, the identity of the user can be used to extract additional information about the user. This can include the user preference information mentioned above, but may also include the user's payment vehicles, value-added services available to the user (including value-added services for which the user has registered in the store in which the humanoid robot is located) their desired delivery address and so forth. Moreover, the desired delivery address and other details may be associated with a particular payment vehicle so that, upon selection of a particular payment vehicle by the user, the address associated with that payment vehicle is proposed, or automatically used, for delivery of the shopping basket or invoice.

For purchases using a virtual shopping basket, the user address details are acquired—either automatically after authentication of the user, or through input by the user -funds are debited from a payment vehicle of the user and delivery of the products to the nominated address is arranged.

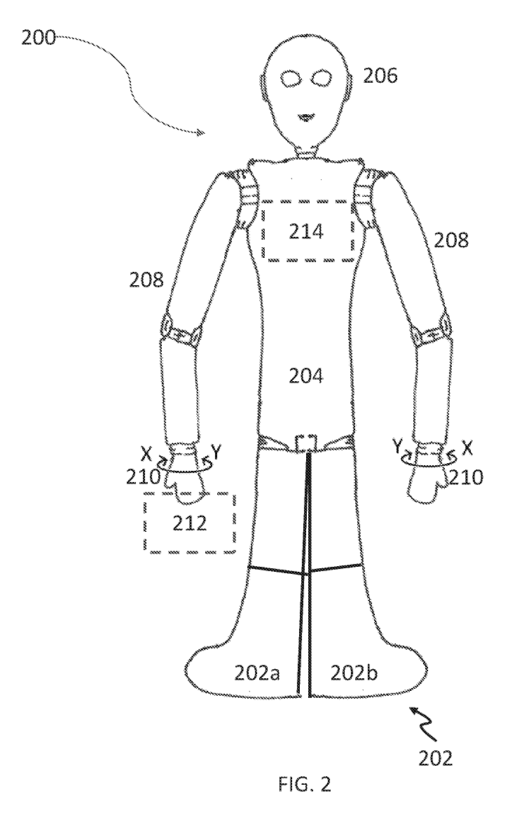

FIG. 2 shows a humanoid robot 200 for use in performing the method of FIG. 1. The humanoid robot 200 comprises a base 202, body 204, head 206, arms 208 and hands 210. The humanoid robot 200 may also support a display, such as display 212, supported by the humanoid robot 200 and shown in broken lines, and display 214, incorporated into the humanoid robot and also shown in broken lines. The displays 212, 214 may in some cases detract from the human appearance of the humanoid robot 200 and can therefore be undesirable in those cases.

The head 206 may comprise one or more “eyes” such as cameras or other optical sensors, and one or more “ears” such as microphones or other audio sensors. Further, the head 206 may comprise one or more visual indicators, such as lights, to indicate whether the humanoid robot 200 is in a listening state, a computing state, or some other state (e.g. a rest or idle state). The head 206, or some other part of the humanoid robot 200, may also comprise other types of sensors for measuring one or more parameters of the robot's environment and/or relating to persons interacting with the robot 200, such as infrared sensors (e.g., for measuring thermal radiation emitted by a user being authenticated).

Accompanying the steps of the method 100 will be various human gestures. Human gestures comprise movements of parts of the body, and audio gestures generally comprising speech.

Where the human gesture comprises speech, the session initiation step 102 may be accompanied by a welcome, such as “Welcome”, “Hello”, “How are you today?” and similar (i.e. acknowledge initiation of the session—114). Authenticating step 104 may similarly be accompanied by “Hello James”, for a user named James, or another vocal form of recognition (134). Identifying products step 106 may also be accompanied by a speech gesture, such as “Added to basket”, or “Shampoo added” where the user is purchasing shampoo.

Where the human gesture comprises a head movement, that head movement may comprise a nod, for any of the processes or steps described with reference to FIG. 1. Where, for example, a product is out-of-stock or otherwise unavailable, the gesture may comprise a shake of the head to indicate “No”—such a gesture may also be accompanied with an appropriate audial response, such as “That product is unavailable. Sorry!” The head movement may also comprise a tile to the site for a query, or where more information is required. For example, where a user has specified a brand of products but not the product itself, the humanoid robot may tilt the head 206 and provide an audial output stating “Do you know which product from [BRAND] you would like?” or similar.

The humanoid robot 200 may also take the user to the products. To that end, the base 202 is mobile and can move across a floor. The base 202 may comprise legs 202a, 202b (which may be articulated and motorised to mimic a walking action), for example, or may be a monolithic structure, the lower portion of which comprises one or more motorised wheels or rollers. The humanoid robot 200 may therefore lead the user to the products the user desires, after the step of identifying products 106. Alternatively, the humanoid robot 200 may instruct the user to wait while it goes to retrieve the products. The products may be identified visually by image recognition techniques, by the use of barcodes, QR codes or RFID tags (for the reading of which which the robot 200 may be equipped with a suitable reader or sensor), or by other suitable means.

The hands 210 can also be used for human gestures. When welcoming a user, for example after session initiation step 102, one or both hands 210 may wave at the user. When querying a user's product selection, requesting more information from the user or presenting products to the user, the hands 210 may rotate in a supination action as is indicated by arrows X in FIG. 2. Pronation, in the direction of arrows Y in FIG. 2, may also be used but is a less common human action when humans are interacting.

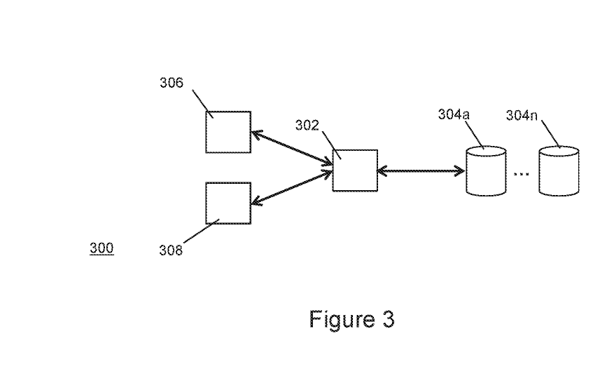

FIG. 3 shows a schematic of a network-based system 300 for facilitating a transaction according to an embodiment of the invention. The system 300 comprises a computer 302, one or more databases 304a . . . 304n, a user input module 306 and a user output module 308. Each of the one or more databases 304a . . . 304n are communicatively coupled with the computer 302. The user input module 306 and a user output module 308 may be separate and distinct modules communicatively coupled with the computer 302. Alternatively, the user input module 306 and a user output module 308 may be integrated within a single mobile electronic device (e.g. a mobile phone, a tablet computer, etc.). The mobile electronic device may have appropriate communication modules for wireless communication with the computer 302 via existing communication protocols.

The computer 302 may comprise: at least one processor; and at least one memory including computer program code; the at least one memory and the computer program code configured to, with at least one processor, cause the computer at least to: (A) receive, using a humanoid robot that may comprise the computer 302, a session initiation instruction from a user and initiating a product selection session; (B) authenticate the user via interaction with the humanoid robot, to determine an identity of the user; (C) identify one or more articles—each article generally being a product or service—for purchase by the user; and (D) initiate a checkout sequence for purchasing the one or more.

Step (A) may be performed by directionally locating the user and moving the humanoid robot to face the user. Step (A) may further be performed by acknowledging, by the humanoid robot, of initiation of a session by reproducing a human gesture.

Step (B) may be performed by receiving a speech segment from the user and analysing the speech segment to locate identifying information in the speech segment. Identifying information may be performed by determining a voice biometric for the speech segment;
comparing the voice biometric for the speech segment to one or more stored voice biometrics; and
authenticating the user if the voice biometric of the speech segment is statistically similar to one of the stored voice biometrics. In particular, the identifying information process may endeavour to identify the users vocal:
voice biometric comprises at least one from the group of:
dialect;
pitch;
spectral magnitudes relating to frequencies in the speech segment;
syllabic emphasis;
tonal emphasis; and
timing.

As described above, the authentication step may make use of various facial recognition and/or gesture recognition algorithms, and/or may make use of persistent authentication based on a device worn by the user, which monitors one or more biometric parameters (e.g. heartbeat) of the user.

Step (C) may involve:
reviewing purchase data of previous transactions comprising at least one of the one or more articles;
identifying, from the purchase data, one or more additional articles; and
receiving a user selection of at least one of the one or more additional articles.

Step (C) may instead involve:
analysing a record of user preference information, the record being stored in a database comprising user preference information of multiple users;
identifying one or more articles from the user preference information; and
receiving a user selection of at least one of the one or more additional articles.

In either case, before receiving a user selection the humanoid robot may present articles—this may occur on a display (e.g. display 212, 214 of FIG. 2) supported by, or integrated into, the humanoid robot—identified during the identifying step to the user.

In some embodiments, the user preference information comprises a loyalty points balance and/or store credit accumulated (for example, via the previous transactions) with a merchant with which the transaction is taking place.

Step (D) may involve:
adding the one or more articles to a basket;
receiving payment vehicle details of a payment vehicle for use in
purchasing the basket; and
acquiring address details for delivery of the basket.

In step (D), the receiving payment vehicle details and/or acquiring address details steps may involve:
using the identity of the user to identify a record, in a database of user records, containing at least one of the payment vehicle details and address details; and
automatically retrieving the payment vehicle details and/or address details from the record.

Notably, step (B) may be performed concurrently with, before or after any one of steps (A), (C) and (D).

The various types of data, e.g. user records, user preferences, user payment vehicle details, user address details etc, can be stored on a single database (e.g. 304a), or stored in multiple databases (e.g. user preference details can be stored on database 304a, payment vehicle credentials can be stored on database 304n, etc.). The databases 304a . . . 304n may be realized using cloud computing storage modules and/or dedicated servers communicatively coupled with the computer 302.

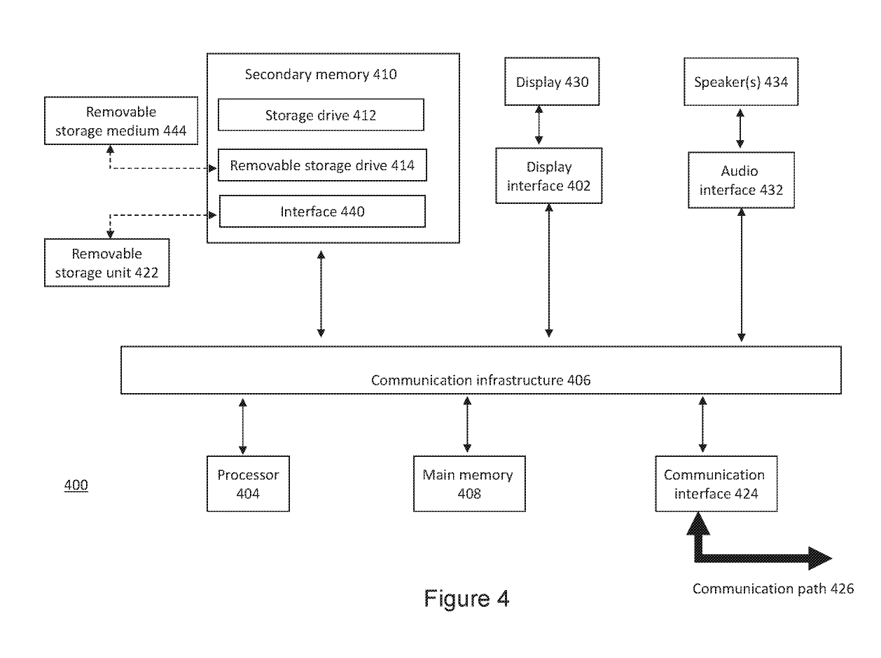

FIG. 4 depicts an exemplary computer/computing device 400, hereinafter interchangeably referred to as a computer system 400, where one or more such computing devices 400 may be used to facilitate execution of the above-described method for determining a convergence measure for facilitating a transaction. In addition, one or more components of the computer system 400 may be used to realize the computer 302. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1393, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the computer implemented method as described with respect to FIG. 1. For example, the computing device 400 provides an apparatus for performing a method facilitating a transaction, the apparatus comprising: at least one processor 404, at least one memory 408 including computer program code and at least one communication interface 424.

The at least one memory 408 and the computer program code are configured to, with at least one processor 404, cause the apparatus at least to: receive, using a humanoid robot, a session initiation instruction from a user and initiating a product selection session through the communication interface 424, using at least one processor 404 of the humanoid robot.

The at least one memory 408 and the computer program code are further configured to cause the at least one processor 404 to authenticate the user via interaction with the humanoid robot, to determine an identity of the user.

The at least one memory 408 and the computer program code are further configured to cause the at least one processor 404 to identify one or more articles—each article generally being a product or service—for purchase by the user.

The at least one memory 408 and the computer program code are further configured to cause the at least one processor 404 to initiate a checkout sequence for purchasing the one or more.

The computing device 400 of FIG. 4 may execute the process shown in FIG. 1 when the computing device 400 executes instructions which may be stored in any one or more of the removable storage medium 444, the removable storage unit 422 and storage drive 412. These components 422, 444 and 412 provide a non-transitory computer readable medium having stored thereon executable instructions for controlling a computer to perform steps comprising: receive, using a humanoid robot that may comprise the computer 302, a session initiation instruction from a user and initiating a product selection session; authenticate the user via interaction with the humanoid robot, to determine an identity of the user; identify one or more articles—each article generally being a product or service—for purchase by the user; and initiate a checkout sequence for purchasing the one or more.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for facilitating a transaction, comprising:
receiving, using a humanoid robot, a session initiation instruction from a user and initiating a product selection session;
authenticating the user via interaction with the humanoid robot;
identifying one or more articles for purchase by the user; and
initiating a checkout sequence for purchasing the one or more articles.

2. A method according to claim 1, wherein receiving the session initiation information comprises receiving a speech segment from the user and identifying the session initiation instruction in the speech segment.

3. A method according to claim 2, wherein the session initiation instruction comprises one or more predetermined words, and receiving the session initiation instruction comprises identifying the one or more predetermined words in the speech segment.

4. A method according to claim 3, wherein the one or more predetermined words comprise a phrase and receiving the session initiation instruction comprises identifying the phrase in the speech segment.

5. A method according to claim 1, wherein receiving the session initiation information comprises directionally locating the user and moving the humanoid robot to face the user.

6. A method according to claim 5, wherein directionally locating the user comprises the humanoid robot listening to speech from the user through two or more receivers and directionally locating the user based on a difference in time of receipt of the speech from the user at respective ones of the receivers.

7. A method according to claim 1, wherein receiving the session initiation information comprises the humanoid robot listening to the user, using one or more receivers, identifying an enquiry from speech of the user and using the enquiry as a session initiation instruction.

8. A method according to claim 7, wherein identifying an enquiry comprises identifying, in the speech of the user, at least one of:
a sequence of words forming a question;
a particular word suggesting the user requires information; and
an upward inflection at the end of a sentence.

9. A method according to claim 1, further comprising the step of acknowledgment, by the humanoid robot, of initiation of a session by mimicking a human response.

10. A method according to claim 9, wherein the mimicked human response is at least one of:
a speech output;
a facial expression of a face of the humanoid robot;
a hand gesture of one or two hands of the humanoid robot; and
a head movement of a head of the humanoid robot.

11. A method according to claim 10, wherein, if the authenticating step has been performed prior to the acknowledgement step, the speech output comprises a name of the user.

12. A method according to claim 1, wherein authenticating the user comprises receiving a speech segment from the user and analysing the speech segment to locate identifying information in the speech segment.

13. A method according to claim 12, wherein the identifying information comprises one or more words describing the user and analysing the speech segment comprises locating the one or more words in the speech segment.

14. A method according to claim 13, wherein the one or more words comprise a name of the user and analysing the speech segment comprises locating the name of the user in the speech segment.

15. A method according to claim 12, wherein the identifying information comprises a voice biometric and analysing the speech segment comprises:
determining a voice biometric for the speech segment;
comparing the voice biometric for the speech segment to one or more stored voice biometrics; and
authenticating the user if the voice biometric of the speech segment is statistically similar to one of the stored voice biometrics.

16. A method according to claim 15, wherein the voice biometric comprises at least one from the group of:
dialect;
pitch;
spectral magnitudes relating to frequencies in the speech segment;
syllabic emphasis;
tonal emphasis; and
timing.

17. A method according to claim 12, further comprising the step of acknowledgment, by the humanoid robot, of confirmation of an identity of the user by mimicking a human response.

18. A method according to claim 17, wherein the mimicked human response is at least one of:
a speech output;
a facial gesture of a face of the humanoid robot;
a hand gesture of one or two hands of the humanoid robot; and
a head movement of a head of the humanoid robot.

19. A method according to claim 1, wherein authenticating the user comprises receiving image data representing a face of the user; extracting one or more facial features from the image data; and comparing the one or more facial features to stored facial features to authenticate the user.

20. A method according to claim 1, wherein identifying one or more articles for purchase comprises receiving a speech segment containing article information, and identifying, from a database of articles, one or more articles corresponding to that article information.

21. A method according to claim 20, wherein identifying one or more articles for purchases further comprises:
reviewing purchase data of previous transactions comprising at least one of the one or more articles;
identifying, from the purchase data, one or more additional articles; and
receiving a user selection of at least one of the one or more additional articles.

22. A method according to claim 1, wherein identifying one or more articles for purchase comprises:
analysing a record of user preference information, the record being stored in a database comprising user preference information of multiple users;
identifying one or more articles from the user preference information; and
receiving a user selection of at least one of the one or more additional articles.

23. A method according to claim 1, wherein authenticating the user occurs after receiving a session initiation instruction.

24. A method according to claim 1, wherein authenticating the user occurs concurrently with at least one of:
receiving a session initiation instruction;
identifying one or more articles for purchase; and
initiating a checkout sequence.

25. A computer system for facilitating a transaction, the computer system comprising:
a memory device for storing data;
a display; and
a processor coupled to the memory device and being configured to:
receive, using a humanoid robot, a session initiation instruction from a user and initiating a product selection session;
authenticate the user via interaction with the humanoid robot;
identify one or more articles for purchase by the user; and
initiate a checkout sequence for purchasing the one or more articles.

26. A computer program embodied on a non-transitory computer readable medium for facilitating a transaction, the program comprising at least one code segment executable by a computer to instruct the computer to:
receive, using a humanoid robot, a session initiation instruction from a user and initiating a product selection session;
authenticate the user via interaction with the humanoid robot;
identify one or more articles for purchase by the user; and
initiate a checkout sequence for purchasing the one or more articles.
